(19) United States
(12) Patent Application Publication
(10) Pub. No.: US 2026/0085811 A1
(43) Pub. Date: Mar. 26, 2026

(54) ILLUMINATION DEVICE

(71) Applicant: GUANGZHOU LUXVISIONS INNOVATION TECHNOLOGY LIMITED, Guangzhou City (CN)

(72) Inventor: Chuan-Hui Liu, Guangzhou City (CN)

(73) Assignee: GUANGZHOU LUXVISIONS INNOVATION TECHNOLOGY LIMITED, Guangzhou City (CN)

(21) Appl. No.: 19/183,906

(22) Filed: Apr. 20, 2025

Related U.S. Application Data
(60) Provisional application No. 63/699,774, filed on Sep. 26, 2024.

(30) Foreign Application Priority Data
Jan. 14, 2025 (CN) 202510057991.5

(51) Int. Cl. F21V 5/00; F21V 5/04

(52) U.S. Cl. CPC F21V 5/008; F21V 5/004; F21V 5/045

(57) ABSTRACT

This disclosure provides an illumination device, including: a light source, configured to emit a light beam; a Fresnel lens, located on an optical path of the light beam to converge the light beam; and a microlens array, located on the optical path of the light beam, and located downstream of the Fresnel lens. When the light beam passes through the microlens array, an illumination light beam is formed and leaves the microlens array.

### CROSS-REFERENCE TO RELATED APPLICATION

This application claims the priority benefit of U.S. provisional application Ser. No. 63/699,774, filed on Sep. 26, 2024 and China application serial no. 202510057991.5, filed on Jan. 14, 2025. The entirety of each of the above-mentioned patent applications is hereby incorporated by reference herein and made a part of this specification.

### BACKGROUND

### Technical Field

An embodiment of the disclosure relates to an illumination device.

### Description of Related Art

The light spot shape and uniformity of the light beam emitted from the light source of the illumination device are often incompatible with actual application requirements. Therefore, there is a need for an illumination device that may process the light beam emitted from the light source, so that the emitted illumination light beam has uniform light spot brightness, and the light spot shape meets the actual application requirements.

### SUMMARY

Some embodiments of the disclosure provide an illumination device, including: a light source, configured to emit a light beam; a Fresnel lens, located on an optical path of the light beam to converge the light beam; and a microlens array, located on the optical path of the light beam, and located downstream of the Fresnel lens. When the light beam passes through the microlens array, an illumination light beam is formed and leaves the microlens array.

Based on the above, the illumination device of the disclosure utilizes the combination of the Fresnel lens and the microlens array, which may make the brightness of the light beam emitted from the light source uniform, and shape the light spot of the illumination light beam to achieve a better illumination effect.

### BRIEF DESCRIPTION OF THE DRAWINGS

FIG. 1 is a schematic diagram of an illumination device according to an embodiment of the disclosure.

FIG. 2A is a top view and cross-sectional view of a Fresnel lens according to an embodiment of the disclosure.

FIG. 2B is a top view and cross-sectional view of a Fresnel lens according to an embodiment of the disclosure.

FIG. 3 is a top view of a microlens array according to an embodiment of the disclosure.

FIG. 4A is a distribution diagram of a light field intensity of an illumination light beam according to an embodiment of the disclosure.

FIG. 4B is a directional diagram of a light field radiation of an illumination light beam according to an embodiment of the disclosure.

### DESCRIPTION OF THE EMBODIMENTS

The following embodiments are listed in conjunction with the accompanying drawings for detailed description, but the provided embodiments are not intended to limit the scope covered by the disclosure. In addition, the component dimensions in the drawings are drawn for convenience of explanation and do not represent the actual component size proportions. Moreover, although terms such as “first,” “second,” etc. are used in the text to describe different components and/or film layers, these components and/or film layers should not be limited by these terms. Rather, these terms are only used to distinguish one component or film layer from another component or film layer. Therefore, the first component or film layer discussed below may be referred to as the second component or film layer without violating the teachings of the embodiments. In order to facilitate understanding, the same elements will be described with the same reference numerals in the following description.

The description of embodiments of the disclosure may use repeated reference symbols and/or wording in different examples. These repeated symbols or wording are for simplification and clarity purposes, and are not intended to limit the relationship between various embodiments and/or the described structural appearances. Furthermore, if the following content of this specification describes forming a first feature on or above a second feature, it indicates that it includes embodiments where the formed first feature is in direct contact with the second feature, and also includes embodiments where additional features are formed between the first feature and the second feature, such that the first feature and the second feature may not be in direct contact. In order to facilitate understanding, the same elements will be described with the same reference numerals in the following description.

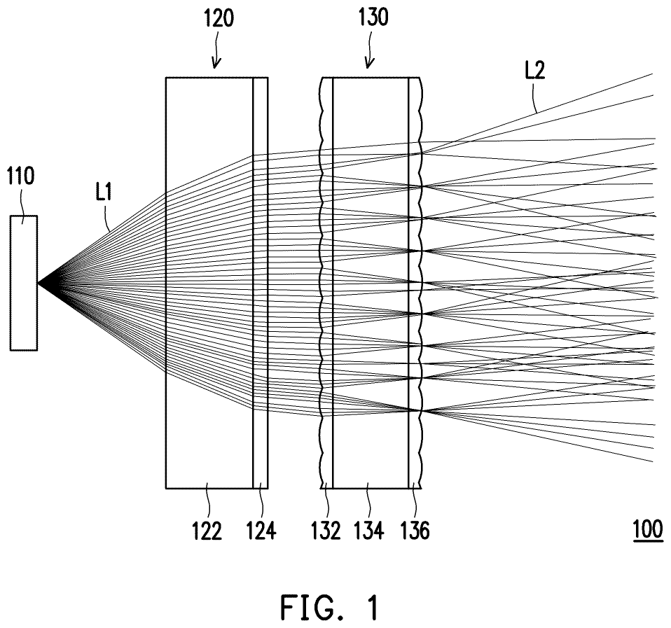

FIG. 1 is a schematic diagram of an illumination device according to an embodiment of the disclosure.

Referring to FIG. 1, an illumination device 100 includes: a light source 110, a Fresnel lens 120, and a microlens array 130.

The light source 110 is configured to emit a light beam L1. In some embodiments, the light source 110 is a light-emitting diode array, or other device having a similar function, and the disclosure is not limited thereto. In some embodiments, a wavelength range of the light beam L1 is 400-700 nm. In some embodiments, the light beam L1 may be monochromatic light, such as red light, green light, or blue light. In some embodiments, the light beam L1 may be white light. In the embodiment, the light spot of the light beam L1 is circular.

The Fresnel lens 120 is located on an optical path of the light beam L1 to converge the light beam L1. Compared to traditional spherical lenses, the Fresnel lens achieves the same optical effect as traditional spherical lenses by dividing the lens into a series of theoretically innumerable concentric circular patterns (i.e., Fresnel zones), while reducing the thickness of the lens and lightening the weight of the lens. Therefore, by using the Fresnel lens 120, the thickness of the optical device 100 may be effectively reduced, significantly reducing the volume of the optical device 100.

Specifically, the Fresnel lens 120 includes a substrate 122 and a lens structure 124, where the lens structure 124 is located at a light exit surface of the substrate 122. Therefore, when the light beam is incident on the Fresnel lens 120, it sequentially passes through the substrate 122 and the lens structure 124 to focus the light beam L1.

In some embodiments, the lens structure 124 may be etched on the substrate 122 in an integrated molding manner. In other embodiments, the lens structure 124 may also be separately manufactured and then attached to the substrate 122 with optical adhesive.

In some embodiments, a material of the Fresnel lens 120 may be plastic, or a light-transmitting material having a similar property, and the disclosure is not limited thereto.

In some embodiments, a focal length of the Fresnel lens 120 is less than 2 mm.

In some embodiments, the Fresnel lens 120 has positive refractive power.

The following explains the structure of the Fresnel lens 120.

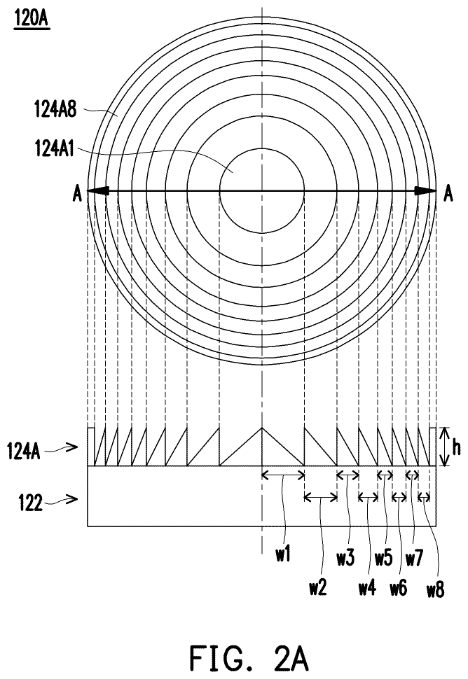

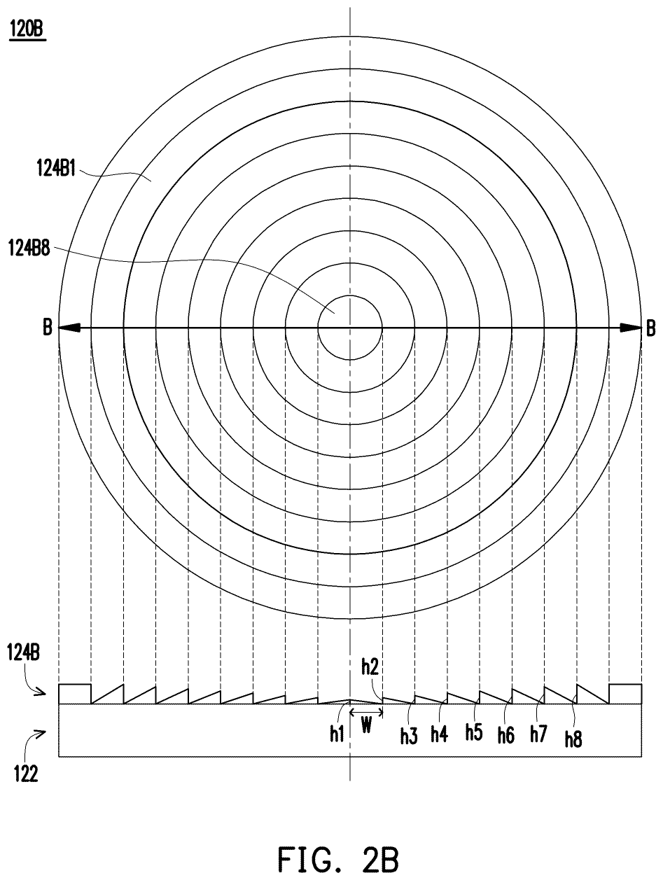

FIG. 2A is a top view and cross-sectional view of a Fresnel lens according to an embodiment of the disclosure. FIG. 2B is a top view and cross-sectional view of a Fresnel lens according to another embodiment of the disclosure.

Referring to FIG. 2A first, a Fresnel lens 120A is an embodiment of the Fresnel lens 120 shown in FIG. 1. In the top view of the Fresnel lens 120A, a lens structure 124A includes at least eight concentric rings. In the embodiment, the lens structure 124A includes eight concentric rings, namely concentric rings 124A1 to 124A8.

In the cross-sectional view along line AA, it may be seen that in the concentric rings 124A1 to 124A8, each concentric ring includes a mountain-like structure. The mountain-like structure is approximately similar to a right triangle, which includes a width and a height, respectively located on the two sides adjacent to the right angle in the right triangle.

In the embodiment, the height of the mountain-like structure of each concentric ring 124A1-124A8 is the same, which is h. In addition, the width of the mountain-like structure of each concentric ring 124A1-124A8, namely w1, w2 . . . , w8, decreases from the inside to the outside along the center of the lens structure 124A, that is, w1>w2> . . . >w8.

In the embodiment, the maximum width among the widths of the plurality of mountain-like structures is less than 0.5 mm, that is, the maximum width w1<0.5 mm, and the height h among the heights of the plurality of mountain-like structures is less than or equal to 0.3 mm.

Therefore, in the embodiment, the concentric rings in the Fresnel lens 120A all have the same height, and the widths of the mountain-like structures decrease from the inside to the outside. In the lens structure 124A, the height of each concentric ring 124A1-124A8 is less than 0.3 mm, and the width of each concentric ring 124A1-124A8 is less than 0.5 mm.

Referring to FIG. 2B again, a Fresnel lens 120B is another embodiment of the Fresnel lens 120 shown in FIG. 1. In the top view of the Fresnel lens 120B, a lens structure 124B includes at least eight concentric rings. In the embodiment, the lens structure 124B includes eight concentric rings, namely concentric rings 124B1 to 124B8.

In the cross-sectional view along line BB, it may be seen that in the concentric rings 124B1 to 124B8, each concentric ring includes a mountain-like structure. The mountain-like structure is approximately similar to a right triangle, which includes a width and a height, respectively located on the two sides adjacent to the right angle in the right triangle.

In the embodiment, the width of the mountain-like structure of each concentric ring 124B1-124B8 is the same, which is w. In addition, the height of the mountain-like structure of each concentric ring 124B1-124B8, namely h1, h2 . . . , h8, increases from the inside to the outside along the center of the lens structure 124B, that is, h1<h2< . . . <h8.

In the embodiment, the maximum height among the heights of the plurality of mountain-like structures is less than 0.3 mm, that is, the maximum height h8<0.3 mm, and the width w among the widths of the plurality of mountain-like structures is less than or equal to 0.5 mm.

Therefore, in the embodiment, the concentric rings in the Fresnel lens 120B all have the same width, and the heights of the mountain-like structures increase from the inside to the outside. In the lens structure 124B, the height of each concentric ring 124B1-124B8 is less than 0.3 mm, and the width of each concentric ring 124B1-124B8 is less than 0.5 mm.

Therefore, through the Fresnel lens 120A or 120B as shown in FIG. 2A or FIG. 2B, the light beam L1 emitted from the light source 110 may be converged.

Please refer to FIG. 1 again.

The microlens array 130 is located on the optical path of the light beam L1, and located downstream of the Fresnel lens 120. When the light beam L1 passes through the microlens array 130, an illumination light beam L2 is formed and leaves the microlens array 130.

Specifically, the microlens array 130 includes a substrate 134. The microlens array 130 further includes a first microstructure array 132 and a second microstructure array 136, where the first microstructure array 132 is located on a light incident surface of the microlens array 130, and the second microstructure array 136 is located at a light exit surface of the microlens array 130. Therefore, the first microstructure array 132 and the second microstructure array 136 are respectively located on the opposite two sides of the substrate 134.

In some embodiments, the first microstructure array 132 is attached to the light incident side surface of the substrate 134 with optical adhesive, and the second microstructure array 136 is attached to the light exit side surface of the substrate 134 with optical adhesive.

In some embodiments, a material of the microlens array 130 (including the first microstructure array 132, the substrate 134, and the second microstructure array 136) is plastic, or a light-transmitting material having a similar property, and the disclosure is not limited to thereto.

In some embodiments, the first microstructure array 132 and the second microstructure array 136 have the same focal length. Therefore, the light beam L1 passing through the first microstructure array 132 may be directly focused on the second microstructure array 136.

In some embodiments, the first microstructure array 132 and the second microstructure array 136 have a same shape in projection along an optical axis of the light beam L1. Therefore, for each microstructure in the first microstructure array 132, there is a corresponding microstructure having the same shape at the relative position with respect to the optical axis in the second microstructure array 136. Therefore, when the light beam L1 is incident on a microstructure in the first microstructure array 132, the light beam L1 will also be incident on the corresponding microstructure in the second microstructure array 132 due to the distance effect.

The following explains the structure of the first microstructure array 132 in the microlens array.

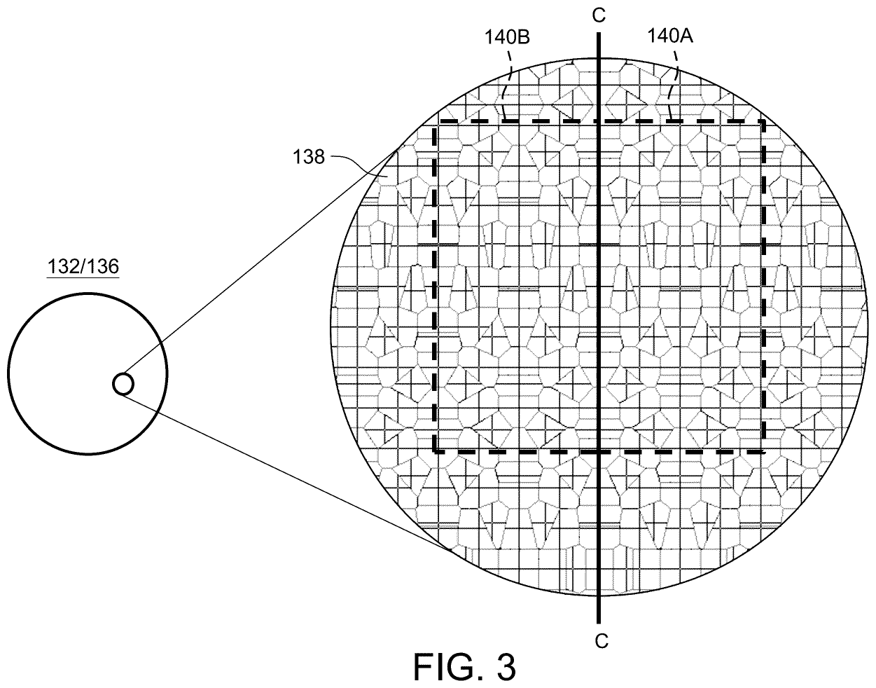

FIG. 3 is a top view of a microlens array according to an embodiment of the disclosure. Since the first microstructure array 132 and the second microstructure array 136 have the same shape in projection along the optical axis of the light beam L1, the top view shown in FIG. 3 is simultaneously the top view of the first microstructure array 132 and the second microstructure array 136.

As shown in FIG. 3, the surfaces of the first microstructure array 132 and the second microstructure array 136 are covered with a plurality of microstructures 138. In the embodiment, an area of each of the plurality of microstructures 138 is less than 1/100 of a total area of the first microstructure array 132 and/or the second microstructure array 136. Accordingly, it may be ensured that the first microstructure array 132 and the second microstructure array 136 have at least 100 or more microstructures 138, which may effectively homogenize the incident light beam L.

As shown in FIG. 3, each of the microstructures 138 is an irregular polygon. Therefore, when the light beam L1 is incident on the various different shapes of the microstructures 138, due to the different shapes of the microstructures 138, the light beam L1 incident on the first microstructure array 132 and the second microstructure array 136 may be homogenized, and the light spot of the illumination light beam L2 passing through the second microstructure array 138 may be shaped.

Although the plurality of microstructures 138 in the first microstructure array 132 and the second microstructure array 136 are irregular polygons, local regions of the first microstructure array 132 and the second microstructure array 136 have mirror symmetry.

As shown in FIG. 3, there are a plurality of mirror symmetry axes in the local regions of the first microstructure array 132 and the second microstructure array 136. For example, along line CC, a right region 140A and a left region 140B have mirror symmetry with respect to line CC. By having a plurality of mirror symmetry axes and a plurality of symmetrical regions in the local regions of the first microstructure array 132 and the second microstructure array 136, the first microstructure array 132 and the second microstructure array 136 may have partial symmetry to homogenize the light beam L1 incident on the first microstructure array 132 and the second microstructure array 136, while also making it easier to predict and design the light spot shape of the illumination light beam L2 in a simulated manner when designing the first microstructure array 132 and the second microstructure array 136.

In some embodiments, the light spot of the light beam L1 incident on the first microstructure array 132 is circular, and the light spot of the illumination light beam L2 emitted through the second microstructure array 138 is rectangular. Therefore, through the microlens array 130, the incident light beam L1 may be shaped to meet actual application requirements.

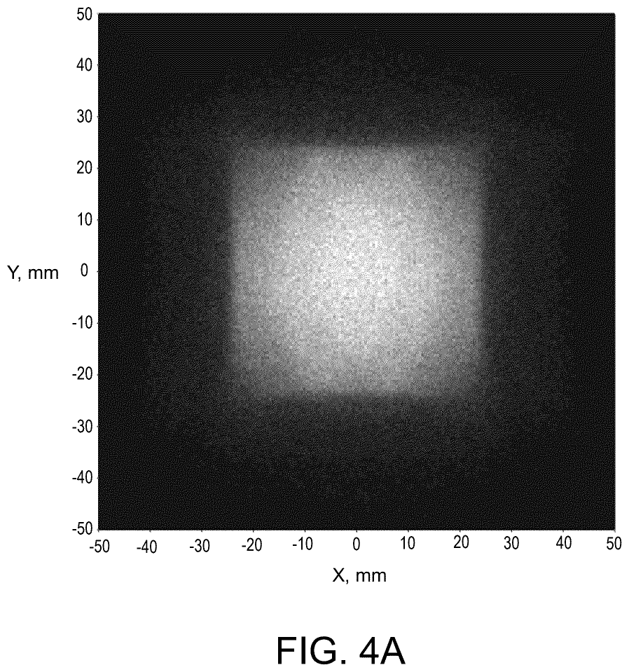

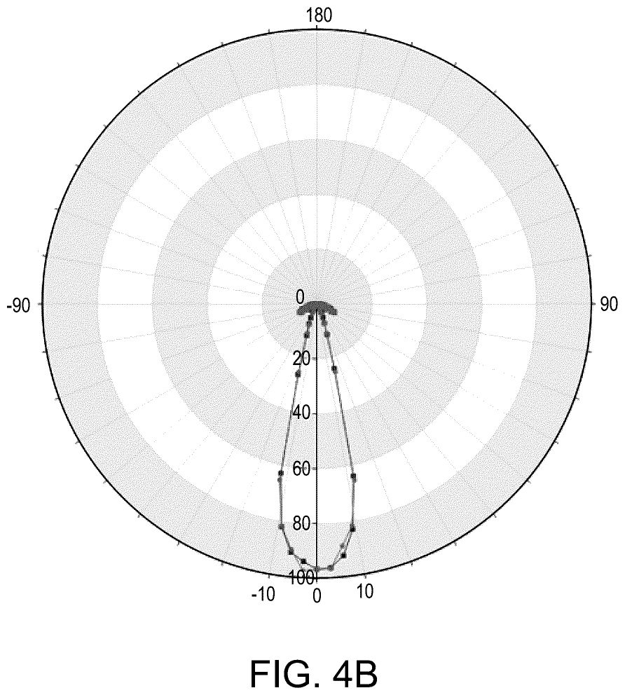

FIG. 4A is a distribution diagram of a light field intensity of the illumination light beam L1 according to an embodiment of the disclosure.

Referring to FIG. 4A, as shown in FIG. 4A, the light spot shape of the illumination light beam L2 along the optical axis direction is rectangular, and a minimum brightness within the rectangular region of the light spot of the illumination light beam L2 is greater than 80% of a maximum brightness of the light spot of the illumination light beam L2. Therefore, as shown in FIG. 4A, the illumination device 100 shown in FIG. 1 may produce an illumination light beam L2 with a rectangular light spot shape and uniform brightness.

FIG. 4B is a directional diagram of a light field radiation of the illumination light beam L2 according to an embodiment of the disclosure.

Referring to FIG. 4B, when measuring the directional distribution of the light field radiation of the illumination light beam L2, as shown in FIG. 4, the light emission direction is concentrated in the region where the divergence angle is between positive and negative 10 degrees, that is, the divergence angle of the illumination light beam L2 is less than 20 degrees.

Therefore, the illumination device 100 shown in FIG. 1 may produce the illumination light beam L2 having a small divergence angle, improving illumination efficiency and reducing brightness spillover.

Based on the above, the illumination device of the disclosure utilizes the combination of the Fresnel lens and the microlens array, which may make the brightness of the light beam emitted from the light source uniform, and shape the light spot of the illumination light beam to achieve a better illumination effect.

What is claimed is:

1. An illumination device, comprising:
a light source, configured to emit a light beam;
a Fresnel lens, located on an optical path of the light beam to converge the light beam; and
a microlens array, located on the optical path of the light beam, and located downstream of the Fresnel lens, wherein when the light beam passes through the microlens array, an illumination light beam is formed and leaves the microlens array.

2. The illumination device according to claim 1, wherein the light source is a light-emitting diode array.

3. The illumination device according to claim 1, wherein a wavelength range of the light beam is 400-700 nm.

4. The illumination device according to claim 1, wherein the Fresnel lens comprises a substrate and a lens structure, and the lens structure is located at a light exit surface of the substrate.

5. The illumination device according to claim 4, wherein the lens structure comprises at least eight concentric rings.

6. The illumination device according to claim 5, wherein each concentric ring comprises a mountain-like structure, the mountain-like structure comprises a width and a height, the width of the mountain-like structure of each concentric ring is the same, and the height of the mountain-like structure of each concentric ring increases from inside to outside along a center of the lens structure.

7. The illumination device according to claim 6, wherein a maximum height among the heights of the mountain-like structures of the respective concentric rings is less than 0.3 mm, and a width among the widths of the mountain-like structures of the respective concentric rings is less than or equal to 0.5 mm.

8. The illumination device according to claim 5, wherein each concentric ring comprises a mountain-like structure, the mountain-like structure comprises a width and a height, the height of the mountain-like structure of each concentric ring is the same, and the width of the mountain-like structure of each concentric ring decreases from inside to outside along a center of the lens structure.

9. The illumination device according to claim 8, wherein the height of the mountain-like structure of each concentric ring is less than 0.3 mm, and a maximum width among the widths of the mountain-like structures of the respective concentric rings is less than or equal to 0.5 mm.

10. The illumination device according to claim 5, wherein a height of each concentric ring is less than 0.3 mm.

11. The illumination device according to claim 5, wherein a width of each concentric ring is less than 0.5 mm.

12. The illumination device according to claim 1, wherein a material of the Fresnel lens is plastic.

13. The illumination device according to claim 1, wherein a focal length of the Fresnel lens is less than 2 mm.

14. The illumination device according to claim 1, wherein the microlens array comprises a first microstructure array and a second microstructure array, the first microstructure array is located at a light incident surface of the microlens array, and the second microstructure array is located at a light exit surface of the microlens array.

15. The illumination device according to claim 14, wherein the first microstructure array and the second microstructure array have a same focal length.

16. The illumination device according to claim 14, wherein the first microstructure array and the second microstructure array have a same shape in projection along an optical axis of the light beam.

17. The illumination device according to claim 14, wherein the first microstructure array comprises a plurality of microstructures, and an area of each of the plurality of microstructures is less than 1/100 of a total area of the first microstructure array.

18. The illumination device according to claim 14, wherein the second microstructure array comprises a plurality of microstructures, and an area of each of the plurality of microstructures is less than 1/100 of a total area of the second microstructure array.

19. The illumination device according to claim 14, wherein the first microstructure array comprises a plurality of microstructures, and each of the plurality of microstructures is an irregular polygon.

20. The illumination device according to claim 1, wherein a light spot of the light beam is circular.

21. The illumination device according to claim 1, wherein a light spot of the illumination light beam is rectangle.

22. The illumination device according to claim 1, wherein a minimum brightness of a light spot of the illumination light beam is greater than 80% of a maximum brightness of the light spot of the illumination light beam.

23. The illumination device according to claim 1, wherein a divergence angle of the illumination light beam is less than 20 degrees.
